(19) United States
(12) Patent Application Publication
(10) Pub. No.: US 2025/0225799 A1
(43) Pub. Date: Jul. 10, 2025

(54) INFORMATION PROCESSING APPARATUS, INFORMATION PROCESSING METHOD, AND PROGRAM

(71) Applicant: SONY GROUP CORPORATION, TOKYO (JP)

(72) Inventor: DAIKI SHIMADA, TOKYO (JP)

(21) Appl. No.: 18/845,100

(22) PCT Filed: Jan. 23, 2023
(86) PCT No.: PCT/JP2023/001866

§ 371 Date: Sep. 9, 2024

(30) Foreign Application Priority Data
Mar. 18, 2022 (JP) 2022-044051

(51) Int. Cl. G06V 20/70; G02B 27/01; G06T 7/20; G06T 7/70; H04R 1/32

(52) U.S. Cl. CPC G06V 20/70; G02B 27/0179; G06T 7/20; G06T 7/70; H04R 1/32; G02B 2027/0138; G02B 2027/014

(57) ABSTRACT

An information processing apparatus according to an embodiment of the present technology includes an estimation unit, a first generation unit, a calculation unit, a recognition unit, and a second generation unit. The estimation unit estimates a position of a sound source on the basis of an environmental sound and a captured image around a user. The first generation unit generates text information obtained by converting the environmental sound into text. The calculation unit calculates an attention score regarding a risk level of the user on the basis of the text information. The recognition unit recognizes object information regarding an object on the basis of the captured image. The second generation unit generates presentation expression information to be presented to the user on the basis of the position of the sound source, the text information, the attention score, and the object information.

### TECHNICAL FIELD

The present technology relates to an information processing apparatus, an information processing method, and a program which can be applied to information presentation and the like to a user.

### BACKGROUND ART

Patent Literature 1 describes an onomatopoeia presentation apparatus that acquires onomatopoeia data corresponding to evaluation of a state of a surrounding environment of a user on the basis of a result of measurement regarding a state in the surrounding environment. This onomatopoeia presentation apparatus presents the onomatopoeia data to the user moving in the surrounding environment with sounds or letters (specification paragraphs [0079] to [0090], FIG. 3, and the like in Patent Literature 1).

### CITATION LIST

### Patent Literature

Patent Literature 1: Japanese Patent No. 6917311

### DISCLOSURE OF INVENTION

### Technical Problem

It is desirable to provide a technology capable of achieving an improvement in usability in such information presentation of the surrounding situation to the user.

In view of the above-mentioned circumstances, it is an objective of the present technology to provide an information processing apparatus, an information processing method, and a program that are capable of achieving an improvement in usability.

### Solution to Problem

In order to accomplish the above-mentioned objective, an information processing apparatus according to an embodiment of the present technology includes an estimation unit, a first generation unit, a calculation unit, a recognition unit, and a second generation unit.

The estimation unit estimates a position of a sound source on the basis of an environmental sound and a captured image around a user.

The first generation unit generates text information obtained by converting the environmental sound into text.

The calculation unit calculates an attention score regarding a risk level of the user on the basis of the text information.

The recognition unit recognizes object information regarding an object on the basis of the captured image.

The second generation unit generates presentation expression information to be presented to the user on the basis of the position of the sound source, the text information, the attention score, and the object information.

In this information processing apparatus, the position of the sound source is estimated on the basis of the environmental sound and the captured image around the user. The text information obtained by converting the environmental sound into text is generated and the attention score regarding the risk level of the user is calculated on the basis of the text information. The object information regarding the object is recognized on the basis of the captured image. The presentation expression information to be presented to the user is generated on the basis of the position of the sound source, the text information, and the object information. Accordingly, an improvement in usability can be achieved.

The presentation expression information may include a text sentence to be presented to the user, a size of the text sentence, a presentation position of the text sentence, and an expression effect applied to the text sentence.

The text information may include at least one of a sound category, the position of the sound source, an onomatopoeia, or a sound volume.

The object information may include at least one of a position, a size, a category, or a movement velocity of the object.

The second generation unit may determine the presentation position of the text sentence on the basis of a behavior of the user.

The second generation unit may present the text sentence in a periphery of the position of the sound source in a case where the position of the sound source is inside an angle-of-view of an imaging device that acquires the captured image.

The second generation unit may present the text sentence so as not to cover the object in a case where the position of the sound source is inside an angle-of-view of an imaging device that acquires the captured image.

The object information may include a covering cost regarding a degree of importance of the object. In this case, the second generation unit may determine the presentation position of the text sentence on the basis of the covering cost.

The second generation unit may determine the size of the text sentence on the basis of the attention score.

The second generation unit may present the text sentence and the position of the sound source in a case where the position of the sound source is outside an angle-of-view of an imaging device that acquires the captured image.

The calculation unit may dynamically change the attention score preset to the text information on the basis of the captured image.

An information processing method according to an embodiment of the present technology is an information processing method to be executed by a computer system and includes estimating a position of a sound source on the basis of an environmental sound and a captured image around a user. Text information obtained by converting the environmental sound into text is generated. An attention score regarding a risk level of the user is calculated on the basis of the text information. Object information regarding an object is recognized on the basis of the captured image. Presentation expression information to be presented to the user is generated on the basis of the position of the sound source, the text information, the attention score, and the object information.

A program according to an embodiment of the present technology causes a computer system to execute the following steps.

A step of estimating a position of a sound source on the basis of an environmental sound and a captured image around a user.

A step of generating text information obtained by converting the environmental sound into text.

A step of calculating an attention score regarding a risk level of the user on the basis of the text information.

A step of recognizing object information regarding an object on the basis of the captured image.

A step of generating presentation expression information to be presented to the user on the basis of the position of the sound source, the text information, the attention score, and the object information.

### BRIEF DESCRIPTION OF DRAWINGS

FIG. 1 A view schematically showing an example of an information processing apparatus.

FIG. 2 A block diagram showing a configuration example of the information processing apparatus.

FIG. 3 A diagram showing processing of environmental sound-to-text conversion.

FIG. 4 A diagram showing processing of generation of presentation expression information.

FIG. 5 A schematic view showing a determination method for a presentation position.

FIG. 6 A block diagram showing a configuration example of a driving assistance device.

FIG. 7 A block diagram showing a hardware configuration example of the information processing apparatus.

### MODE(S) FOR CARRYING OUT THE INVENTION

Hereinafter, embodiments according to the present technology will be described with reference to the drawings.

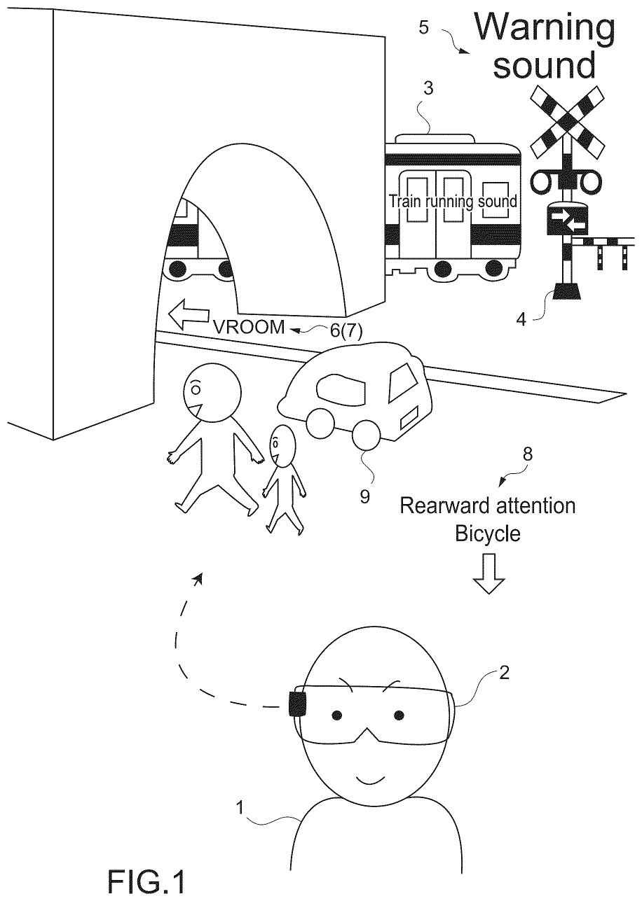

FIG. 1 is a view schematically showing an example of an information processing apparatus according to the present technology.

As shown in FIG. 1, a user 1 has a wearable see-through display 2 such as augmented reality (AR) glasses. In the present embodiment, the user 1 visually recognizes a landscape shown in the upper part of the figure via the see-through display 2.

The see-through display 2 includes a microphone capable of acquiring an environmental sound around the user 1 and a camera capable of imaging the front of the user 1. Moreover, the see-through display 2 includes an information processing apparatus (not shown).

The information processing apparatus determines an object or region emitting sounds on the basis of the environmental sound and the captured image. Moreover, the information processing apparatus converts the environmental sound into text (verbalizing). Presentation expression information to be presented to the user is generated on the basis of the sound source emitting sound and the information converted into text. Hereinafter, the information obtained by converting the environmental sound into text will be referred to as text information.

For example, in FIG. 1, a case where a train 3 and level crossing signals 4 are inside a field-of-view of the user 1 (inside an angle-of-view of the camera), an object is outside the field-of-view of the user 1, and these emit sounds is used as an example.

In this case, the information processing apparatus presents a text 5, “Train running sound,” and a text 5, “Warning sound,” near the level crossing signals 4. Moreover, the information processing apparatus presents, based on a sound waveform and a position of the sound source of the object outside the field-of-view of the user 1, a text 7 indicating that there is an object emitting a sound, “VROOM,” from the arrow 6 direction as viewed from the user 1 and a text 8, “Rearward attention, bicycle,” indicating that a bicycle is approaching behind the user 1.

In the present embodiment, the information processing apparatus calculates an attention score indicating an attention sound dangerous to the user 1 (sound to which the user should pay attention). For example, as to the sound, “DING DONG,” emitted from the level crossing signals 4, the attention score is calculated to be higher because it is a dangerous sound for informing of the train 3 approaching. Therefore, the text is presented to the user 1 with an increased font size (warning sound). That is, the fact that the attention score is higher indicates that it is a sound with a higher risk level to the user 1.

Moreover, in the present embodiment, the information processing apparatus calculates an attention score on the basis of information of the object (object information), a sound category, a positional relationship between the user 1 and the sound source, a sound volume, and the like.

For example, in FIG. 1, no text indicating a running sound of an automobile 9 is displayed. It is because the automobile is present inside the field-of-view of the user 1 and the user 1 has recognized the automobile with a high possibility. In contrast, as to a sound emitted by a bicycle (e.g., bell sound mounted on the bicycle), a text is presented to the user 1 because the bicycle is approaching behind the user 1, which is outside the field-of-view of the user 1, even though the bell sound is a lower sound and the risk level is lower than that of the automobile 9. It should be noted that a calculation method and a filtering method for the attention score will be described later in detail.

Moreover, the information processing apparatus generates presentation expression information so that text information with a higher attention score does not interfere with the user's behavior as much as possible. The presentation expression information is set so that no text is superimposed on objects that the user 1 should gaze, e.g., the level crossing signals 4 and signs, and a movement direction of the user 1.

As one example of the present technology, an assistance AR device targeted at hearing-impaired users is envisaged. As shown in FIG. 1, the user 1 is able to precisely know the surrounding situation from various texts displayed on the see-through display 2. Moreover, a camera mounted on the see-through display 2 detects a road surface where the user walks so that no texts are superimposed on the way. Accordingly, the user is able to behave while knowing the safely presented text information.

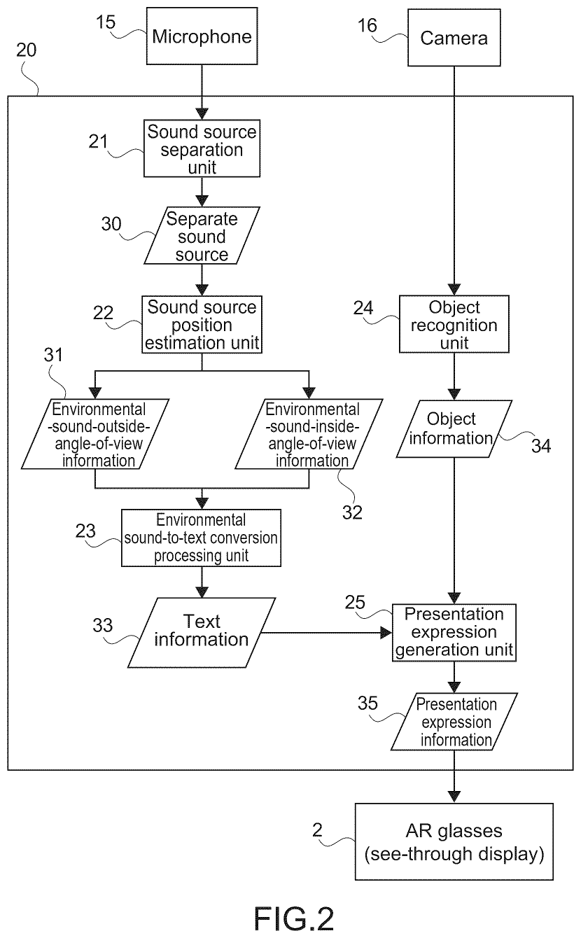

FIG. 2 is a block diagram showing a configuration example of the information processing apparatus.

As shown in FIG. 2, an information processing apparatus 20 includes a sound source separation unit 21, a sound source position estimation unit 22, an environmental sound-to-text conversion processing unit 23, an object recognition unit 24, and a presentation expression generation unit 25.

The sound source separation unit 21 separates the environmental sound around the user 1 acquired by a microphone 15. For example, the sound source separation unit 21 separates sounds of respective objects such as a train, a level crossing sound, and a bicycle from the environmental sound in which various sounds are mixed. As a matter of course, various sounds such as human voices and gas leaking sounds in addition to them may be included. It should be noted that the method of separating the sound sources is not limited, and the sound sources may be separated on the basis of various known technologies.

The sound source position estimation unit 22 estimates a position of the sound source on the basis of the environmental sound and a captured image captured by a camera 16. In the present embodiment, the sound source position estimation unit 22 outputs environmental-sound-outside-angle-of-view information 31 and environmental-sound-inside-angle-of-view information 32 on the basis of a separated sound (separate sound source 30) and objects shown in the captured image. It should be noted that the method of estimating the position of the sound source is not limited, and the position of the sound source may be estimated on the basis of various known technologies.

The environmental-sound-outside-angle-of-view information 31 indicates information about the environmental sound present outside the field-of-view of the user 1. In the present embodiment, the environmental-sound-outside-angle-of-view information includes a sound waveform, a sound category, and a direction of a sound source. For example, in a case where the captured image shows no train when a running sound of the train is acquired, a sound waveform indicating the running sound, a sound category of the train running sound, and a direction of the sound source present outside the field-of-view, e.g., upper, lower, left, right, or rear, are output as the environmental-sound-outside-angle-of-view information.

The environmental-sound-inside-angle-of-view information 32 indicates information about the environmental sound present inside the field-of-view of the user 1. In the present embodiment, the environmental-sound-inside-angle-of-view information includes the sound waveform, the sound category, and coordinates of the sound source in the captured image. For example, in a case where a level crossing sound has been acquired, a sound waveform of the level crossing sound, a sound category of the level crossing signals, and coordinates of the sound source based on the level crossing signals in the captured image are output as the environmental-sound-inside-angle-of-view information.

The method of classifying the environmental-sound-outside-angle-of-view information 31 and the environmental-sound-inside-angle-of-view information 32 by the sound source position estimation unit 22 is not limited. For example, with respect to the objects shown in the captured image, matching with sound waveforms corresponding to the train 3, the level crossing signals 4, and a car 9 may be calculated and those that have matched may be classified as the environmental-sound-inside-angle-of-view information 32 and those that have not matched may be classified as the environmental-sound-outside-angle-of-view information 31.

Moreover, the method of recognizing the sound category is also not limited. For example, in a case of the environmental-sound-inside-angle-of-view information 32, the sound category may be recognized by image recognition and audio recognition. Moreover, for example, in a case of the environmental-sound-outside-angle-of-view information 31, the sound category may be recognized only by audio recognition.

The environmental sound-to-text conversion processing unit 23 generates text information 33 obtained by converting the environmental-sound-outside-angle-of-view information and the environmental-sound-inside-angle-of-view information into text. In the present embodiment, the environmental sound-to-text conversion processing unit 23 generates a single sentence for a single sound by integrating information of each of those converted into text with the category information of the sound.

The text information 33 includes at least one of a sound category, a position of a sound source, an onomatopoeia word (onomatopoeia), or a sound volume. For example, the text information is information indicating that the train (sound category) sounds loud (sound volume) as clickety-clack (onomatopoeia word) at the right front (sound source position) as viewed from the user 1.

The object recognition unit 24 recognizes object information 34 regarding the object on the basis of the captured image. The object information 34 includes at least one of a position, a size, a category, or a movement velocity.

The presentation expression generation unit 25 generates presentation expression information on the basis of the text information and the object information. The presentation expression information is information regarding an expression to be presented to the user. In the present embodiment, the presentation expression information includes a text sentence to be presented to the user 1, a size (font size) of the text sentence, a presentation position of the text sentence on the display, and an expression effect applied to the text sentence, such as an animation, a color, or a size.

In accordance with the output presentation expression information, the text sentence is presented on the display of AR glasses 2 of the user.

It should be noted that in the present embodiment, the sound source position estimation unit 22 corresponds to an estimation unit that estimates a position of a sound source on the basis of an environmental sound and a captured image around a user.

It should be noted that in the present embodiment, the environmental sound-to-text conversion processing unit 23 corresponds to a first generation unit that generates text information obtained by converting the environmental sound into text.

It should be noted that in the present embodiment, the object recognition unit 24 corresponds to a recognition unit that recognizes object information regarding an object on the basis of the captured image.

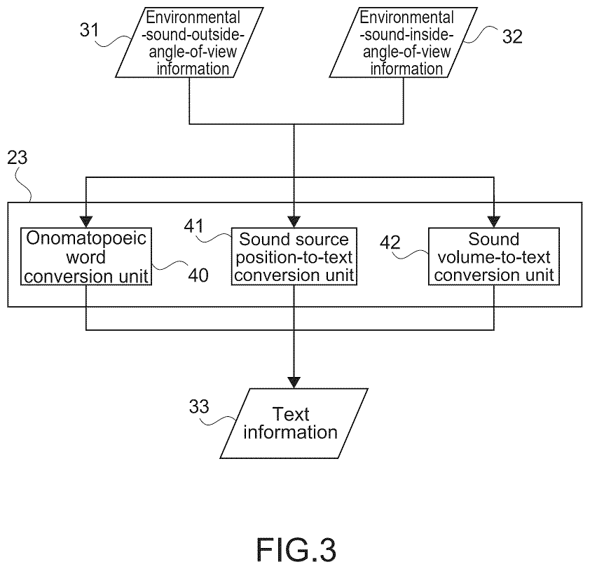

FIG. 3 is a diagram showing processing of environmental sound-to-text conversion.

As shown in FIG. 3, the environmental sound-to-text conversion processing unit 23 includes an onomatopoeia word conversion unit 40, a sound source position-to-text conversion unit 41, and a sound volume-to-text conversion unit 42.

The onomatopoeic word conversion unit 40 converts a sound waveform into a onomatopoeic word expressing a sound such as ding dong, boom, or rattle.

The sound source position-to-text conversion unit 41 converts a direction of the sound source or position coordinates of the sound source into words indicating a rough position where the sound source is located, such as the left front, rear, or screen center. It should be noted that the position coordinates may include distance information such as far or near front other than an x and y coordinates in a case of a sensor configuration capable of acquiring three-dimensional information. Moreover, three-dimensional information may be acquired based on a level of the sound volume, a sound pressure, and the like.

The sound volume-to-text conversion unit 42 converts a sound volume (dB) level into text on the basis of the sound waveform. For example, in a case where the sound volume level is smaller than a preset threshold or the sound volume level is equal to or larger than the preset threshold, the fact that a lower sound or higher sound is made is converted into text.

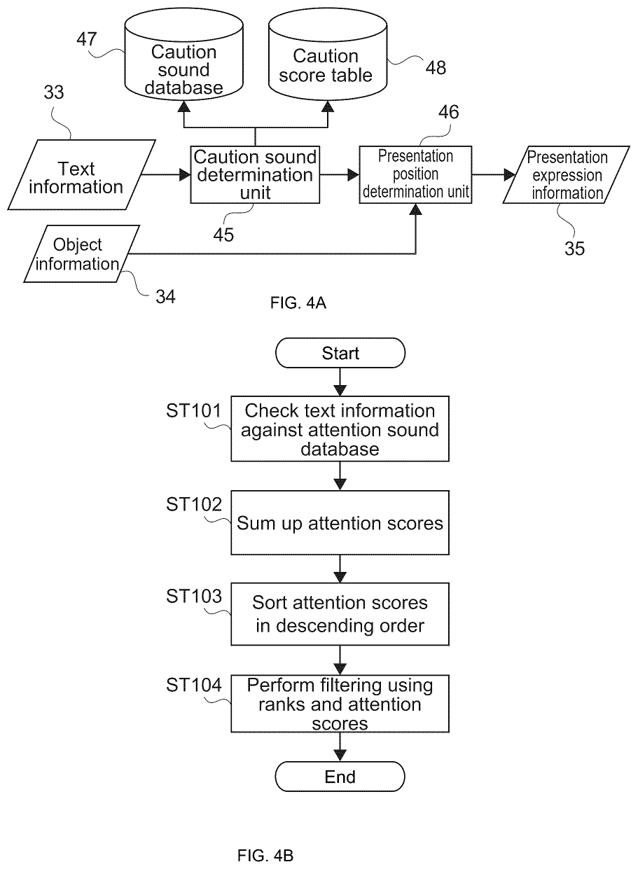

FIG. 4 is a diagram showing processing of generation of the presentation expression information. A of FIG. 4 is a block diagram showing a configuration example of the presentation expression generation unit 25.

As shown in FIG. 4, the presentation expression generation unit 25 includes an attention sound determination unit 45 and a presentation position determination unit 46.

The attention sound determination unit 45 calculates an attention score for each piece of text information on the basis of an attention sound database 47 and an attention score table 48.

The attention sound database 47 is a database in which attention sounds depending on various situations are stored. For example, a warning sound of the level crossing signals, a car running sound, and a bicycle bell sound, and the like are stored. In addition to this, an attention sound depending on a situation, such as a warning sound of a fire warning device, a gas-leaking sound, or a water-leaking sound, may be stored.

The attention score table 48 is a table in which attention scores depending on various situations are stored with respect to the text information. For example, attention scores: rear is 2 points; warning sound is 4 points; far is 0.1 points; automobile is 1.5 points; and larger is 1.5 points, for example, are set with respect to the sound category, the position of the sound source, the onomatopoeic word, and the sound volume. It should be noted that score values stored in the attention score table are not limited, and these may be changed depending on various situations, may be dynamically changed on the basis of the captured image, or may be modified by the user depending on needs.

B of FIG. 4 is a flowchart showing ranking of the attention scores.

As shown in B of FIG. 4, the attention sound determination unit 45 checks the text information 33 against the attention sound database 47 (Step 101). For example, in a case where four pieces of text information, “Bicycle, front, ding dong, smaller,” “Automobile, rear, running sound, larger,” “Level crossing signals, front, warning sound, larger,” and “Bicycle, far front, running sound, smaller,” have been generated, it is checked whether attention sounds of “DING DONG,” “Running sound,” and “Warning sound” of these pieces of text information have been stored in the attention sound database 47.

On the basis of the attention score table 48, the attention scores of the pieces of text information checked are summed up (Step 102). In the present embodiment, the sound category that is the text information, the position of the sound source, the onomatopoeic word, and the sound volume are multiplied by the attention scores based on the attention score table 48. For example, in a case of the text information, “Automobile, rear, horn (warning sound), larger”, the attention score is 18 points. The attention score of each piece of text information is calculated in a similar way.

The calculated attention scores are sorted in descending order (Step 103). That is, the calculated attention scores are rearranged in order from the text information with the highest attention score.

Filtering using ranks of the sorted pieces of text information and the attention scores is performed (Step 104). For example, text information whose rank is upper n % and whose attention score is equal to or larger than the threshold is output to the presentation position determination unit 46. It should be noted that the filtering method is not limited, and an upper limit value of the number of pieces of text information presented to the user may be set. Moreover, the filtering may be set as appropriate on the basis of the surrounding situation and the captured image.

The presentation position determination unit 46 determines the position of the text sentence to be presented to the user. For example, using a predetermined position on the display of the AR glasses worn by the user as a point of origin, the x and y coordinates are determined.

It should be noted that in the present embodiment, the attention sound determination unit 45 corresponds to a calculation unit that calculates an attention score regarding a risk level of the user on the basis of the text information.

It should be noted that in the present embodiment, the presentation expression generation unit 25 and the presentation position determination unit 46 function as a second generation unit that generates presentation expression information to be presented to the user on the basis of the position of the sound source, the text information, the attention score, and the object information.

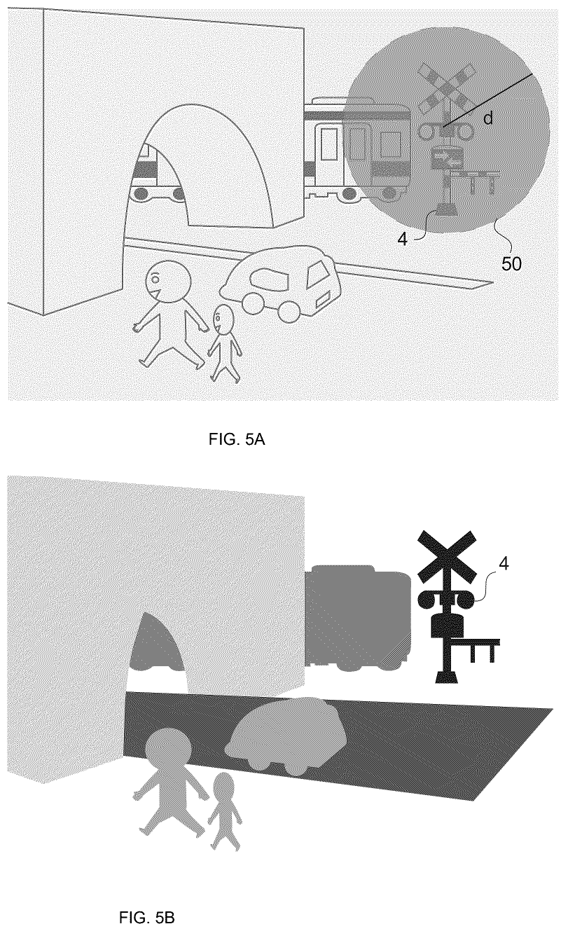

FIG. 5 is a schematic view showing a determination method for the presentation position.

In the present embodiment, the presentation position determination unit 46 determines a presentation position of the text information so as not to interfere with the user's behavior on the basis of the attention score and the object information. For example, the text information is presented so that no text information is superimposed on an area in a direction in which the user walks, such as a ground or sidewalk. In addition to this, the text information may be presented so as not to be superimposed on an object that the user should gaze.

In the present embodiment, the presentation position of the presentation expression information and the size (letter size) of the presentation expression information are determined by determining a solution that minimizes an information presentation cost L including an Euclidean distance d from a sound source position in a presented image space, a covering area cost c of an object in the image, and a difference s between the attention score and the size.

For example, the information presentation cost L is represented by an expression like L=αd+βc+γs. The coefficients (α, β, γ) in the respective items are arbitrarily set in accordance with an example. It should be noted that the expression may be optimized by any determination method such as linear programming. It should be noted that the information presentation cost is determined in order from an object with the highest attention score among objects emitting sounds.

Hereinafter, a determination method for optimal presentation position and size considering costs associated with the presentation expression information will be described, referring to FIG. 5 as an example.

In FIG. 5, it is assumed that “Level crossing signals, front, warning sound, larger,” as text information and 20 points as an attention score have been supplied to the presentation position determination unit 46. Moreover, the landscape shown in FIG. 1 as the captured image and object information involved in the landscape are supplied to the presentation position determination unit 46.

Moreover, the text, “Warning sound,” which is an attention sound emitted from the level crossing signals 4 is displayed as presentation expression information to be presented to the user (see FIG. 1).

A of FIG. 5 is a schematic view showing the sound source in the image space and the cost. B of FIG. 5 is a schematic view showing a covering area cost.

As shown in A of FIG. 5, a circle 50 having a radius which is the Euclidean distance d from the level crossing signals 4 that is the sound source position and other regions have different costs and that further from the sound source has a higher cost. That is, the text is presented at a position close to the level crossing signals 4 emitting “Warning sound.”

In Fig. B of 5, the higher the covering area cost c of the object is, the darker the object color is. For example, since the level crossing signals 4 are an object important for informing of a train approaching, the covering area cost is set to be higher. That is, the cost becomes higher as the presentation expression information (warning sound) covers the object with the higher cost. It should be noted that for the covering area cost, the category and the cost value of the object may be defined depending on an example in advance. As a matter of course, the covering area cost may be dynamically changed. For example, the covering area cost may be changed depending on whether or not the object is moving and whether the object moves in a direction closer to or far away from the center of the field-of-view of the user.

Moreover, the larger the letter size of “Warning sound” is, the smaller the differences between the attention score and the size is. However, larger the letter size is, the higher the possibility in that the letters cover the object is. That is, the covering cost in B of FIG. 5 increases.

Since the information presentation cost L including the three costs is optimized, suitable presentation expression information that does not interfere with the user's behavior and does not cover objects that the user should gaze is presented. That is, since the user easily recognizes an object emitting an attention sound and no presentation expression information is superimposed on the object that the user should gaze, the visibility to the user can be improved.

### Modified Examples

Embodiments according to the present technology are not limited to the above-mentioned embodiment, and various modifications can be made.

For example, an assistance AR device that facilitates video understanding of hearing-impaired users is envisaged. When the user is seeing a play, a performer face position is detected and text information (e.g., production sounds, performer's lines) is presented avoiding the face position. Accordingly, a subtitle regarding the environmental sound can be generated on the spot without degrading the quality of the viewing experience.

Moreover, for example, a driving assistance device that informs a driver of an emergency vehicle approaching it or notifies a countermeasure of an accident is envisaged.

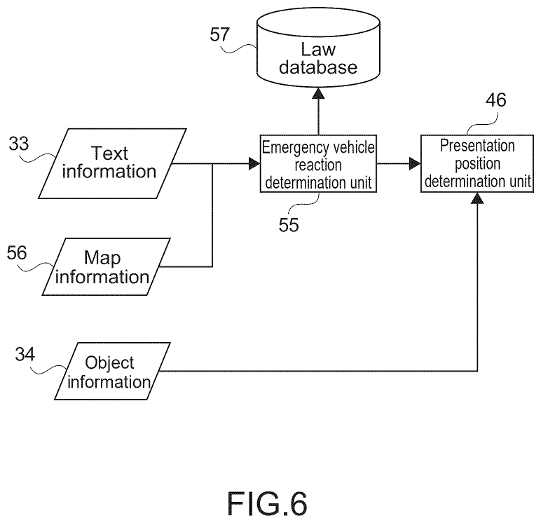

FIG. 6 is a block diagram showing a configuration example of the driving assistance device.

In FIG. 6, the presentation expression generation unit 25 includes an emergency vehicle reaction determination unit 55.

On the basis of the text information 33 and map information 56, the emergency vehicle reaction determination unit 55 determines whether the emergency vehicle is approaching or it is necessary to react it such as road shoulder stop or not. In the present embodiment, on the basis of a law database 57, the emergency vehicle reaction determination unit 55 determines whether or not to make a behavior based on laws.

For example, the law database 57 stores various situations such as an ambulance or fire truck approaching from behind with sirens blaring, guidance by a police vehicle, or an emergency vehicle approaching on a highway. In addition to this, situations in various emergency vehicles such as electric utilities, gas utilities, flood control agencies, road management, telecommunication services, preserved blood and organ carriers, and doctor cars may be stored.

The map information 56 includes road information, user vehicle location information, and the like. For example, the map information 56 includes information about as left-turn-only traffic zones, road signs such as no-entry for vehicles, traffic congestion, construction, and the like.

In the present embodiment, the object information 34 includes information about objects around the car or motorcycle in which the user rides. For example, the object information 34 includes a position of a preceding vehicle, a condition of the road surface, positions of pedestrians, positions of traffic signals, positions of signs, and positions of stopped vehicles.

The presentation position determination unit 46 determines a position of the presentation expression information to be presented to the user on the basis of the emergency vehicle reaction determination unit 55 and the object information 34. In the present embodiment, the presentation position determination unit 46 determines a position of the text sentence to be in a place that does not interfere with information necessary for driving, such as preceding vehicles, pedestrians, and signs.

For example, a text sentence “Ambulance is approaching from behind. Please pull over to the shoulder immediately” and an arrow designating the direction and location where the car should move are displayed on the windshield of the car. In addition to this, the driver may wear a see-through display such as AR glasses and these may be presented on that display.

Moreover, not limited to the emergency vehicle, an attention sound in the periphery of the car may be displayed with the attention sound determination unit 45. Furthermore, various sensors may be mounted on the car and if an abnormality has occurred in the car, a text sentence to inform of it may be presented.

Hereinabove, the information processing apparatus 20 according to the present embodiment estimates the position of the sound source on the basis of the environmental sound around the user 1 and the captured image. The information processing apparatus 20 generates the text information 33 obtained by converting the environmental sound into text. The information processing apparatus 20 calculates an attention score regarding the risk level of the user 1 on the basis of the text information 33. The information processing apparatus 20 recognizes the object information 34 regarding the object on the basis of the captured image. The information processing apparatus 20 generates a presentation expression information 35 presented to the user 1 on the basis of the position of the sound source, the text information 33, the attention score, and the object information 34. Accordingly, an improvement in usability can be achieved.

Conventionally, there are technologies for allowing even hearing-impaired users to enjoy video content. However, these are compatible with particular works for which special subtitle information have been generated. Moreover, in a case where the user behaves outdoor, although it is needless to say that surrounding sounds are information important for the user to safely behave, it has been difficult for users who cannot easily hear sounds, such as an elderly person and a driver driving an automobile, and a hearing-impaired users to correctly know the surrounding sounds.

The present technology can combine sound-to-image mapping and sound-to-verbal mapping to superimpose verbalized sound information on a display such as AR glasses and a car windshield to present to the user what sounds are being made, where they are being made, and whether or not the user should pay attention to it.

Moreover, the information presented to the user is combined with audio and image information, and the information is superimposed on a location where the environmental sound information has been verbalized. The result of verbalization and the presentation method are changed in consideration of the object that is sounding and the way it is sounding. Moreover, the position of the superimposed information is adjusted by taking into account objects not sounding and scene information.

### Other Embodiments

The present technology is not limited to the above-mentioned embodiment, and various other embodiments can be realized.

In the above-mentioned embodiment, the camera 16 is mounted on the see-through display 2 for imaging the inside of the field-of-view of the user, i.e., the front of the user. The present technology is not limited thereto, and a plurality of cameras may be mounted in order to image the periphery of the user.

In the above-mentioned embodiment, the microphone 15 and the camera 16 are mounted on the see-through display 2 such as AR glasses. The present technology is not limited thereto, and the microphone and the camera do not need to be mounted on the see-through display 2. For example, the microphone and the camera may be installed in a room and acquired information may be supplied to the see-through display.

In the above-mentioned embodiment, the presentation expression information 35 is ranked and generated on the basis of the result of determination of the attention sound determination unit 45. The present technology is not limited thereto, and may be arbitrarily designed in accordance with various applications and situations. For example, in a case of an outdoor walking assistance AR device for hearing-impaired users, the text sentence may be presented in a position that warns of danger or emphasizes the attention sound and does not overlap the walking path.

In the above-mentioned embodiment, the letter size of the text sentence to be presented to the user is determined with the information presentation cost. The present technology is not limited thereto, and in addition to the letter size of the text sentence, blinking, color, animation, or the like of the text sentence may be determined on the basis of the information presentation cost. Moreover, specific animations or colors may also be set depending on the type of text sentence. For example, a warning sound may be set to blink in red. As a matter of course, these setting methods may be set as appropriate by the user or based on the attention score.

In the above-mentioned embodiment, the text sentence is presented so as not to be superimposed on the object on the basis of the covering area cost. The present technology is not limited thereto, and the text sentence may be superimposed on the object in accordance with a situation around the user, the type of attention sound, and whether or not a sound is being generated. For example, a text indicating other attention sounds may be superimposed on an object emitting sounds that do not require attention. Moreover, for example, the location where the text sentence is superimposed may be controlled on the basis of the movement velocity and the movement direction of the object. That is, the covering area cost may be considered on the basis of the movement velocity and the movement direction of the object.

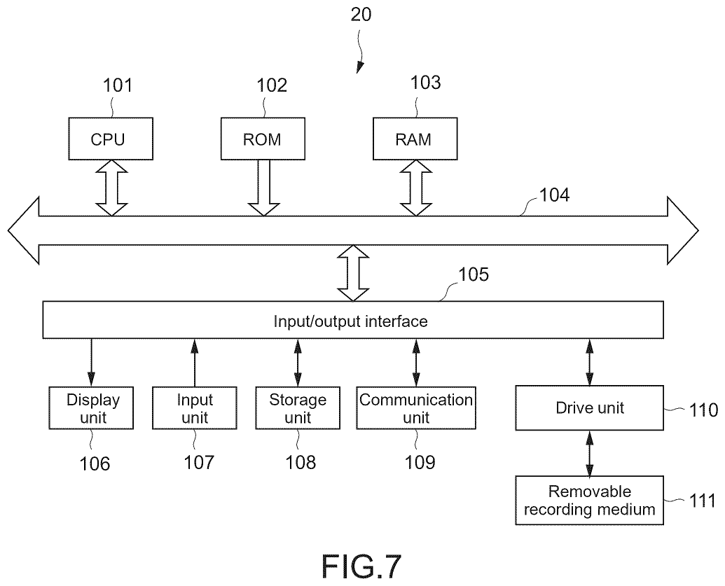

FIG. 7 is a block diagram showing hardware configuration examples of the information processing apparatus 20.

The information processing apparatus 20 includes a CPU 101, a ROM 102, a RAM 103, an input/output interface 105, and a bus 104 that connects them to one another. A display unit 106, an input unit 107, a storage unit 108, a communication unit 109, a drive unit 110, and the like are connected to the input/output interface 105.

The display unit 106 is, for example, a display device using liquid crystals, EL, or the like. The input unit 107 is, for example, a keyboard, a pointing device, a touch panel, or another operation device. In a case where the input unit 107 includes a touch panel, the touch panel can be integral with the display unit 106.

The storage unit 108 is a nonvolatile storage device. The storage unit 108 is, for example, an HDD, a flash memory, or another solid-state memory. The drive unit 110 is, for example, a device capable of driving a removable recording medium 111 such as an optical recording medium or a magnetic record tape.

The communication unit 109 is a modem, a router, or another communication device for communicating with other devices, which is connectable to a LAN, a WAN, or the like. The communication unit 109 may perform wired communication or may perform wireless communication. The communication unit 109 is often used separately from the information processing apparatus 20.

Cooperation of software stored in the storage unit 108, the ROM 102, or the like with hardware resources of the information processing apparatus 20 realizes information processing of the information processing apparatus 20 having the hardware configurations as described above. Specifically, the information processing method according to the present technology is realized by loading a program that configures the software, which has been stored in the ROM 102 or the like, to the RAM 103 and executing it.

The information processing apparatus 20 installs the program via the recording medium 111, for example. Alternatively, the information processing apparatus 20 may install the program via a global network or the like. Otherwise, any computer-readable non-transitory storage medium may be used.

Cooperation of a computer mounted on a communication terminal with another computer capable of communicating with it via a network or the like may execute the information processing method and the program according to the present technology and configure the evaluation unit according to the present technology.

That is, the information processing apparatus, the information processing method, and the program according to the present technology may be performed not only in a computer system constituted by a single computer, but also in a computer system in which a plurality of computers cooperatively operate. It should be noted that in the present disclosure, the system means a set of a plurality of components (e.g., apparatuses, modules (parts)) and it does not matter whether or not all the components are housed in the same casing. Therefore, both of a plurality of apparatuses housed in separate casings and connected to one another via a network and a single apparatus having a plurality of modules housed in a single casing are the system.

Executing the information processing apparatus, the information processing method, and the program according to the present technology by the computer system includes, for example, both of a case where a single computer executes estimation of the sound source position, generation of the text information, calculation of the attention score, and the like, and a case where different computers execute the respective processes. Moreover, executing the respective processes by a predetermined computer includes causing another computer to execute some or all of those processes and acquiring the results.

That is, the information processing apparatus, the information processing method, and the program according to the present technology can also be applied to a cloud computing configuration in which a plurality of apparatuses shares and cooperatively processes a single function via a network.

The respective configurations such as the environmental sound-to-text conversion processing unit, the presentation expression generation unit, the attention sound determination unit, the control flow of the communication system, and the like, which have been described with reference to the respective drawings, are merely embodiments, and can be arbitrarily modified without departing from the gist of the present technology. That is, any other configurations, algorithms, and the like for carrying out the present technology may be employed.

It should be noted that the effects described in the present disclosure are merely exemplary and not limitative, and further other effects may be provided. The description of the plurality of effects above does not necessarily mean that those effects are provided at the same time. It means that at least any one of the above-mentioned effects is obtained depending on a condition and the like, and effects not described in the present disclosure can be provided as a matter of course.

At least two features of the features of the above-mentioned embodiments may be combined. That is, the various features described in the respective embodiments may be arbitrarily combined across the respective embodiments.

It should be noted that the present technology can also take the following configurations.
(1) An information processing apparatus, including:
   an estimation unit that estimates a position of a sound source on the basis of an environmental sound and a captured image around a user;
   a first generation unit that generates text information obtained by converting the environmental sound into text;
   a calculation unit that calculates an attention score regarding a risk level of the user on the basis of the text information;
   a recognition unit that recognizes object information regarding an object on the basis of the captured image; and
   a second generation unit that generates presentation expression information to be presented to the user on the basis of the position of the sound source, the text information, the attention score, and the object information.
(2) The information processing apparatus according to (1), in which
   the presentation expression information includes a text sentence to be presented to the user, a size of the text sentence, a presentation position of the text sentence, and an expression effect applied to the text sentence.
(3) The information processing apparatus according to (1), in which
   the text information includes at least one of a sound category, the position of the sound source, an onomatopoeia, or a sound volume.
(4) The information processing apparatus according to (1), in which
   the object information includes at least one of a position, a size, a category, or a movement velocity of the object.
(5) The information processing apparatus according to (2), in which
   the second generation unit determines the presentation position of the text sentence on the basis of a behavior of the user.
(6) The information processing apparatus according to (2), in which
   the second generation unit presents the text sentence in a periphery of the position of the sound source in a case where the position of the sound source is inside an angle-of-view of an imaging device that acquires the captured image.
(7) The information processing apparatus according to (2), in which
   the second generation unit presents the text sentence so as not to cover the object in a case where the position of the sound source is inside an angle-of-view of an imaging device that acquires the captured image.
(8) The information processing apparatus according to (7), in which
   the object information includes a covering cost regarding a degree of importance of the object, and
   the second generation unit determines the presentation position of the text sentence on the basis of the covering cost.
(9) The information processing apparatus according to (2), in which
   the second generation unit determines the size of the text sentence on the basis of the attention score.
(10) The information processing apparatus according to (2), in which
   the second generation unit presents the text sentence and the position of the sound source in a case where the position of the sound source is outside an angle-of-view of an imaging device that acquires the captured image.
(11) The information processing apparatus according to (1), in which
   the calculation unit dynamically changes the attention score preset to the text information on the basis of the captured image.
(12) An information processing method, including:
   by a computer system,
   estimating a position of a sound source on the basis of an environmental sound and a captured image around a user;
   generating text information obtained by converting the environmental sound into text;
   calculating an attention score regarding a risk level of the user on the basis of the text information;
   recognizing object information regarding an object on the basis of the captured image; and
   generating presentation expression information to be presented to the user on the basis of the position of the sound source, the text information, the attention score, and the object information.
(13) A program that causes a computer system to execute the steps of:
   estimating a position of a sound source on the basis of an environmental sound and a captured image around a user;
   generating text information obtained by converting the environmental sound into text;
   calculating an attention score regarding a risk level of the user on the basis of the text information;
   recognizing object information regarding an object on the basis of the captured image; and
   generating presentation expression information to be presented to the user on the basis of the position of the sound source, the text information, the attention score, and the object information.

### REFERENCE SIGNS LIST

20 information processing apparatus
22 sound source position estimation unit
23 environmental sound-to-text conversion processing unit
24 object recognition unit
25 presentation expression generation unit
45 attention sound determination unit
46 presentation position determination unit

1. An information processing apparatus, comprising:
an estimation unit that estimates a position of a sound source on a basis of an environmental sound and a captured image around a user;
a first generation unit that generates text information obtained by converting the environmental sound into text;
a calculation unit that calculates an attention score regarding a risk level of the user on a basis of the text information;
a recognition unit that recognizes object information regarding an object on a basis of the captured image; and
a second generation unit that generates presentation expression information to be presented to the user on a basis of the position of the sound source, the text information, the attention score, and the object information.

2. The information processing apparatus according to claim 1, wherein
the presentation expression information includes a text sentence to be presented to the user, a size of the text sentence, a presentation position of the text sentence, and an expression effect applied to the text sentence.

3. The information processing apparatus according to claim 1, wherein
the text information includes at least one of a sound category, the position of the sound source, an onomatopoeia, or a sound volume.

4. The information processing apparatus according to claim 1, wherein
the object information includes at least one of a position, a size, a category, or a movement velocity of the object.

5. The information processing apparatus according to claim 2, wherein
the second generation unit determines the presentation position of the text sentence on a basis of a behavior of the user.

6. The information processing apparatus according to claim 2, wherein
the second generation unit presents the text sentence in a periphery of the position of the sound source in a case where the position of the sound source is inside an angle-of-view of an imaging device that acquires the captured image.

7. The information processing apparatus according to claim 2, wherein
the second generation unit presents the text sentence so as not to cover the object in a case where the position of the sound source is inside an angle-of-view of an imaging device that acquires the captured image.

8. The information processing apparatus according to claim 7, wherein
the object information includes a covering cost regarding a degree of importance of the object, and
the second generation unit determines the presentation position of the text sentence on a basis of the covering cost.

9. The information processing apparatus according to claim 2, wherein
the second generation unit determines the size of the text sentence on a basis of the attention score.

10. The information processing apparatus according to claim 2, wherein
the second generation unit presents the text sentence and the position of the sound source in a case where the position of the sound source is outside an angle-of-view of an imaging device that acquires the captured image.

11. The information processing apparatus according to claim 1, wherein
the calculation unit dynamically changes the attention score preset to the text information on a basis of the captured image.

12. An information processing method, comprising:
by a computer system,
estimating a position of a sound source on a basis of an environmental sound and a captured image around a user;
generating text information obtained by converting the environmental sound into text;
calculating an attention score regarding a risk level of the user on a basis of the text information;
recognizing object information regarding an object on a basis of the captured image; and
generating presentation expression information to be presented to the user on a basis of the position of the sound source, the text information, the attention score, and the object information.

13. A program that causes a computer system to execute the steps of:
estimating a position of a sound source on a basis of an environmental sound and a captured image around a user;
generating text information obtained by converting the environmental sound into text;
calculating an attention score regarding a risk level of the user on a basis of the text information;
recognizing object information regarding an object on a basis of the captured image; and
generating presentation expression information to be presented to the user on a basis of the position of the sound source, the text information, the attention score, and the object information.
